(19) United States
(12) Patent Application Publication
(10) Pub. No.: US 2001/0055466 A1
(43) Pub. Date: Dec. 27, 2001

(54) Video playback control apparatus and video playback control method

(76) Inventor: Kazuhiro Iwashita, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 09/885,839

(22) Filed: Jun. 20, 2001

(30) Foreign Application Priority Data
Jun. 22, 2000 (JP) P.2000-188161

(51) Int. Cl. H04N 5/781

(52) U.S. Cl. 386/46; 386/125

(57) ABSTRACT

A video data on the main part of a movie, which is long-time video data, is supplied from a DVD (2) that is a disc medium. Plural sets of video data on trailers and commercials of a relatively short playing time are supplied from a distribution center (6) via a subscriber telephone line (7) or the like. A video playback control apparatus (1) selects trailers and commercials in accordance with information on the distributor of the movie, the star actor/actress, the genre, etc., and conditions of the day of week, the time zone, etc., in which the movie is to be played back, and prepares a play schedule while combining the selected trailers and commercials. The whole movie including the selected trailers and commercials are played in accordance with the schedule.

### BACKGROUND OF THE INVENTION

1. Field of the Invention

The present invention relates to a video playback control apparatus and a video playback control method, which are to be used for playing back video data in a digital theater etc.

The present application is based on Japanese Patent Application No. 2000-188161, which is incorporated herein by reference.

2. Description of the Related Art

In a movie theater, trailers etc. are played prior to the main part of a movie, and then the main part is played. Such trailers and the main part are previously combinedly edited so as to be continuously played, and distributed in the form of a roll film made of a resin. Therefore, it is impossible to easily reedit trailers and the main part in accordance with conditions of the location, the time zone, etc.

At present, distribution of a movie in which digital video data are used is being put to practical use. The most real-time system of distributing video data is the on-line distribution via a telephone line or a CS (Communication Satellite). However, on-line distribution of a large amount of video data on a movie etc. requires a very long time period, and a high communication cost. Therefore, this system is not rational. A video data distribution system using disc media such as DVDs (i.e., Digital Video (Versatile) Disks) can be surely performed and does not entail high cost, but has a problem in that the system is poor in real-timeness and flexibility to conditions.

### SUMMARY OF THE INVENTION

It is an object of the present invention to provide a video playback control apparatus which is supplied with a large amount of video data through a medium such as a disc, and with a small amount of replaceable video data via communication, and which plays back both the video data while combining the video data with each other. Of course, the object of the present invention is also to provide a video playback control method.

To achieve the above object, according to a first aspect of the present invention, there is provided a video playback control apparatus which continuously plays back first video data supplied from a medium and second video data supplied from a communication system, while combining the first and second video data with each other.

Further, based on the first aspect of the present invention, there can be provided a video playback control method which comprises: reading first video data recorded on a medium; receiving second video data from a communication system; and continuously playing back the first video data and the second video data while combining the first and second video data with each other.

According to a second aspect of the present invention, in the first aspect of the present invention, the first video data may be video data on a main part of a movie, and the second video data may be video data on at least one of a trailer and an advertisement.

According to a third aspect of the present invention, in the second aspect of the present invention, the trailer and the advertisement are to be played prior to the main part of the movie.

According to a fourth aspect of the present invention, in the first or second aspect of the present invention, plural sets of the second video data may be supplied from the communication system, and in this case, at least one of the sets of the second video data, and the first video data are continuously played back while being combined with each other.

According to a fifth aspect of the present invention, in the fourth aspect of the present invention, the at least one of the sets of the second video data, which is combined with the first video data, may be selected on the basis of at least one of conditions of a manufacturer of the video playback control apparatus and an installation site, conditions of a time and day of week in which the first video data is to be played back, and information on a kind of the first video data.

Further, based on the fifth aspect of the present invention, the video playback control method may further comprise selecting at least one set from the sets of the second video data, which is combined with the first video data, on the basis of at least one of conditions of a manufacturer of the video playback control apparatus and an installation site, conditions of a time and day of week in which the first video data is to be played back, and information on a kind of the first video data.

Furthermore, according to a sixth aspect of the present invention, in view of a preferred embodiment which will be described later, for example, there may be provided a video playback control apparatus which comprises: a medium reading section which outputs first video data recorded on a medium; a communication control section which receives second video data via a communication device from a separate distribution center that is disposed independently of the video playback control apparatus; and a control section, to which the medium playback section and the communication control section are connected, and which controls the first video data and the second video data so that the first video data and the second video data are continuously played back while being combined with each other. However, it should be noted that the present invention is not limited to the aforementioned example.

In the present invention, the first video data may be supplied by a storage medium such as a DVD etc. For example, the first video data is long-time video data on the main part of a movie etc. The second video data is supplied through communication. The communication may be performed by any kind of communication system, for example, a telephone line, a communication satellite (CS), etc. The second video data which is to be received through the communication may be, for example, video data of a relatively short playing time, on a trailer of a movie, a commercial, etc. When the first and second video data are combined with each other, video playback is enabled in a free combination of long-time video data and replaceable video data.

In the case of a movie, trailers, and the main part of the movie have been previously combinedly edited as discussed in the related art. In contrast, according to the present invention, such trailers can be freely combined with the main part, and hence an optimum trailer can be used in combination in accordance with various conditions of the title of the movie, the day of week, etc.

### BRIEF DESCRIPTION OF THE DRAWINGS

The above and other objects and advantages of the present invention will become more apparent by describing in detail a preferred embodiment thereof with reference to the accompanying drawings, wherein:

FIG. 1 is a block diagram of a digital theater system including a video playback control apparatus which is an embodiment of the present invention;

FIGS. 2A to 2C are flowcharts showing the operation of the video playback control apparatus of FIG. 1; and

FIG. 3 is a flowchart showing the operation of the video playback control apparatus of FIG. 1.

### DETAILED DESCRIPTION OF THE PREFERRED EMBODIMENT

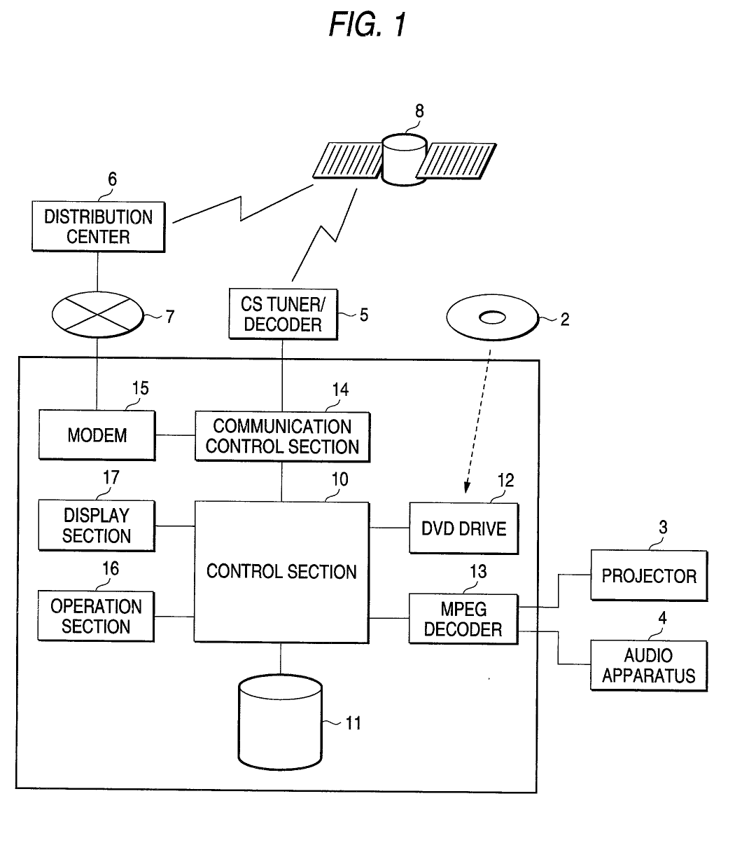

FIG. 1 is a block diagram of a digital theater system including a video playback control apparatus which is an embodiment of the present invention. The digital theater system includes: a video playback control apparatus 1 which comprises a DVD drive 12, and which can sequentially read out video data on main parts of movies, trailers, etc., and output the data as a video signal and an audio signal; a projector 3 which projects the video signal output from the video playback control apparatus 1, onto a screen; and an audio apparatus 4 which amplifies the audio signal output from the video playback control apparatus 1, and outputs the amplified signal as a sound. A DVD 2 on which the main part of a movie to be played is recorded is set into the DVD drive 12 of the video playback control apparatus 1.

The video playback control apparatus 1 has a control section 10 which controls the operation of the apparatus. To the control section 10, connected are a mass storage unit 11 which stores video data on trailers and commercials, the DVD drive 12, an MPEG decoder 13 which decodes MPEG data of a DVD or the like into video and audio signals, a communication control section 14 which is used for downloading the video data on trailers and commercials, an operation section 16 which is to be operated by the user or the operator of the apparatus, and a display section 17. The mass storage unit 11 may be configured by any kind of storage unit as far as it is a readable/writable one and can store video data for several hours. Usually, a hard disc drive may be appropriately used as the mass storage unit.

A modem 15 and a CS tuner/decoder 5 are connected to the communication control section 14. The modem 15 is a card which is incorporated into the video playback control apparatus 1, and the CS tuner/decoder 5 is an external device. The modem 15 is connected to a distribution center 6 via a subscriber telephone line 7. The CS tuner/decoder 5 receives distributed data from the distribution center 6 via a communication satellite (CS) 8. The communication device for communicating with the distribution center 6 is not restricted to the modem and the analog line. For example, a TA (Terminal Adaptor), a DSU (Digital Service Unit), and an ISDN line maybe used as the communication device.

The video playback control apparatus 1 receives video data on a trailer via the modem 15, and writes the data into the mass storage unit 11. The distribution center 6 periodically calls each of digital theater systems, and distributes the latest trailers and commercials to the digital theater systems. At this time, the video playback control apparatus 1 transmits apparatus conditions under which distributed commercials and trailers are selected, to the distribution center 6, and the distribution center 6 distributes only video data on commercials and trailers which satisfy the conditions, to the video playback control apparatus 1. The apparatus conditions include the manufacturer of the video playback control apparatus 1, the installation site (the prefecture etc.), and business use/home use. Based on the conditions, the distribution center selects appropriate commercials and trials, and downloads the selected video data to the video playback control apparatus 1. According to this configuration, commercials and trials which have a relatively large amount of data can be selectively downloaded, thereby saving the traffic. Into each of the video data, information indicative of the kind and the term of validity is written. In the case of video data on a commercial, the information includes the name of the enterprise (enterprise code) of the article (including service), the name of the article, the kind of the article (article code), and the term of validity. In the case of video data on a trailer, the information includes the distributor of the movie, the star actor/actress, the date of releasing the main part (start of a road show), and the term of validity.

The video playback control apparatus 1 receives video data on news via the CS tuner/decoder 5, and writes the data into the mass storage unit 11. Each time when news is made, the distribution center 6 transmits data on the news to all the systems via the CS 8.

When the DVD 2 on which the main part of a movie is recorded is set into the DVD drive 12, the video playback control apparatus 1 prepares a play schedule according to the data on the movie main part etc. which are recorded on the DVD 2. In accordance with the movie main part, news, commercials, and trailers are played prior to the movie main part, and the movie main part is thereafter played. The news, commercials, and trailers which are to be played prior to the movie main part are selected on the basis of playing conditions and information of the main part (commercials and trailers are preselected on the basis of the apparatus conditions, and the selected commercials and trailers are downloaded into the video playback control apparatus 1). The playing conditions include the day of week and the time zone when the movie is to be played (i.e., when the DVD 2 is set). The information of the main part includes the distributor of the movie, the star actor/actress, and the genre of the movie. In accordance with the conditions and information, commercials and trailers are selected. On the basis of the playing conditions, when the time zone is the daytime of a weekday, for example, the schedule is prepared so as to play commercials and trailers which are suitable for housewives and families. On the basis of the information of the main part, the schedule is prepared so as to play trailers of next movies of the same distributor, the same star actor/actress, and the same genre. As described above, downloaded commercials and trailers are preselected according to the apparatus conditions. Based on these conditions and information, therefore, commercials and trailers which are to be played are synthetically selected.

The prepared schedule is written into the mass storage unit 11. When instruction for starting the play of the movie is given, video data on news, commercials, trailers, and the main part are read out in accordance with the schedule, and then played back. The apparatus conditions and the playing conditions are stored in the mass storage unit 11, and the information of the main part is recorded on the DVD 2 on which the movie is recorded.

The downloaded video data on news, commercials, and trailers may be MPEG-2 format data in the same manner as the movie main part of the DVD 2, or may be those of another format. For example, such data of another format are a QUICKTIME movie, text data, still image data, and sequence data in which texts and still images are arranged in time sequence. The control section 10 may develop the data into a video signal and directly output the video signal to the projector 3. In order to maintain continuity of a video signal, alternatively, video data of any format may be reconverted into an MPEG data, and the MPEG data may be supplied to the projector 3 through the MPEG decoder 13.

In the case where the playing time of the movie main part is longer than two hours, the main part is sometimes recorded over two or more DVDs. The DVD drive 12 may be configured by a drive for a single DVD. Alternatively, the DVD drive may be configured by a drive having a DVD changer, so that, even in such a case, the playing operation can be uninterruptedly continued without replacing the DVDs in the course of the playing operation.

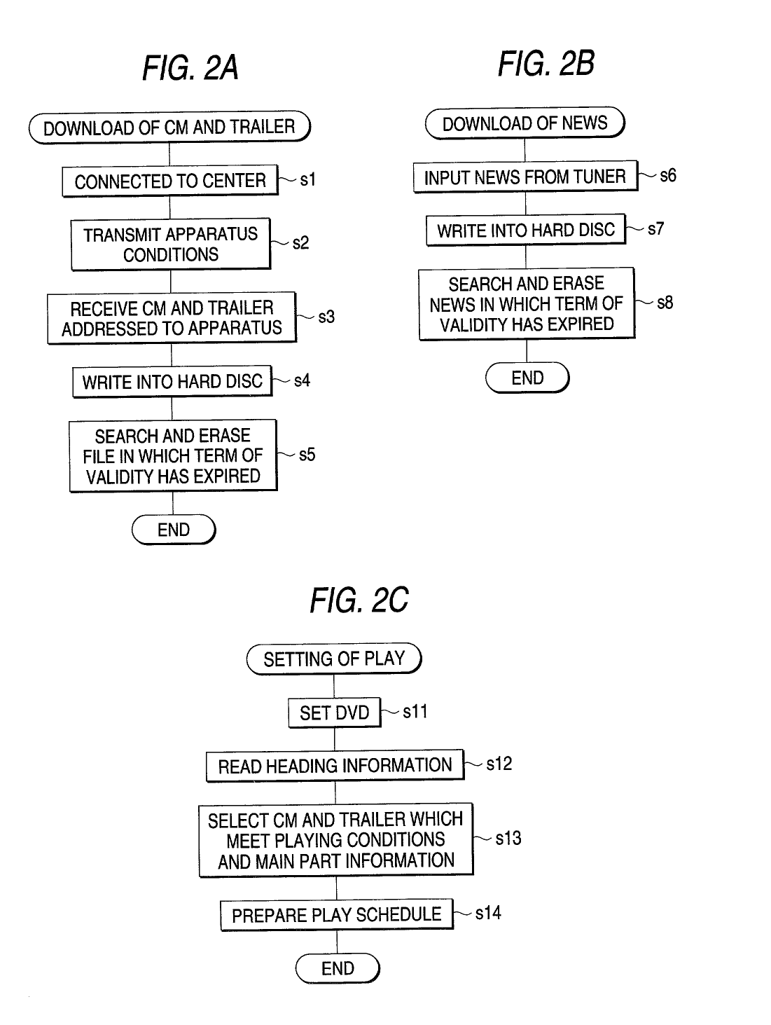

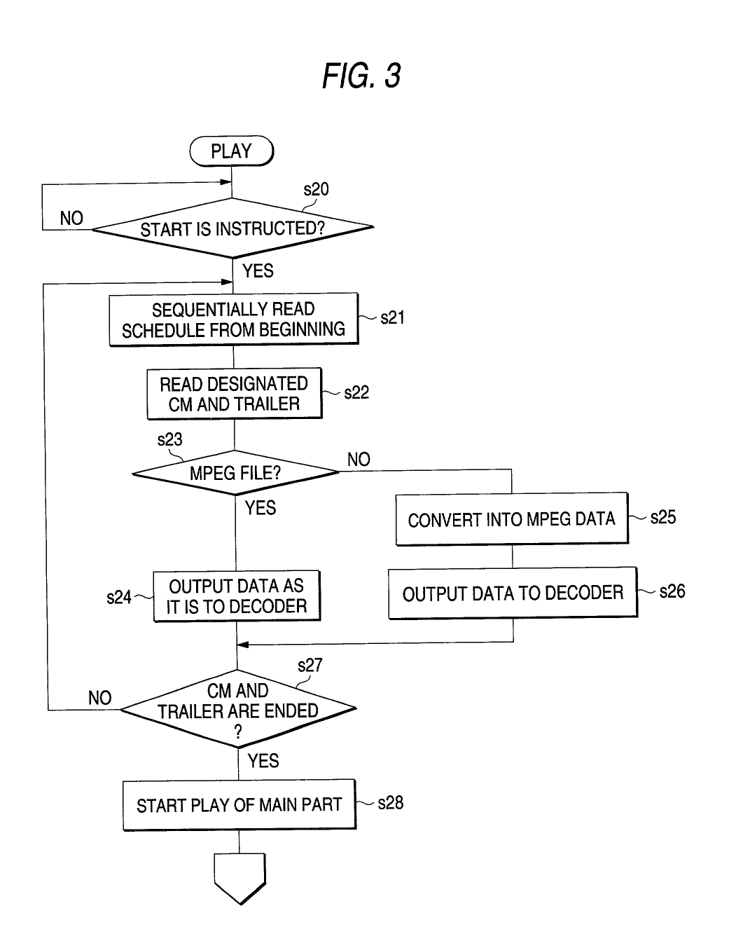

FIGS. 2A to 3 are flowcharts showing the operation of the video playback control apparatus.

FIG. 2A is a flowchart showing the operation of downloading video data on commercials and trailers from the distribution center 6 via the subscriber telephone line. First, the distribution center 6 is connected to the telephone line (s1). This connection of the telephone line may be performed by a procedure in which the distribution center 6 periodically makes a telephone call, or that in which the apparatus makes a telephone call to the distribution center 6. When the distribution center 6 is connected to the telephone line, the apparatus transmits the apparatus conditions to the distribution center 6 (s2). On the basis of the apparatus conditions, the distribution center 6 selects one or more of new commercials and trailers, and transmits the selected commercials and trailers to the apparatus. The apparatus receives the video data on the commercials and trailers which are addressed to the apparatus itself (s3). The received video data on the commercials and trailers are written into a hard disc serving as the mass storage unit 11 (s4). The terms of validity of commercials and trailers which are already stored in the hard disc 11 are checked, and data in which the term has expired is erased (s5).

FIG. 2B is a flowchart showing the operation of downloading news via the communication satellite 8. News are distributed at any time via the communication satellite 8, and received by the CS tuner/decoder 5. The CS tuner/decoder 5 supplies the received news to the video playback control apparatus 1, e.g., the communication control section 14 in this embodiment (s6). The video playback control apparatus 1 writes the news into the hard disc 11 (s7), searches news in which the term has expired, and erases such news (s8). Usually, data on news is configured by text data (and still image data), and the title, the genre (current topics, entertainments, sports, etc.), and the term of validity of the news are written into the header of the data.

FIG. 2C is a flowchart showing the operation of setting a play schedule. The play schedule is executed when the DVD 2 on which the main part of a movie is recorded is set into the DVD drive 12. When the DVD 2 is set into the DVD drive 12 (s11), heading information of the DVD 2 is read out (s12), and information on the distributor, the star actor/actress, etc. in the heading information is used as main part information for selecting commercials and trailers. Based on the read out main part information and the play conditions of the day of week and the time zone, etc., news, commercials, and trailers are selected (s13). The play schedule is prepared so as to place the selected news, commercials, and trailers prior to the main part of the movie, and the prepared schedule is stored into the hard disc 11 (s14).

As described above, in the embodiment, the video playback control apparatus 1 prepares a play schedule on the basis of the apparatus conditions, the play conditions, and the main part information. However, the conditions and information for preparing a play schedule are not restricted to those described above. Alternatively, a predetermined play schedule may be downloaded from the distribution center 6.

FIG. 3 is a flowchart showing the playing operation of the video playback control apparatus 1. When the operation of setting a play schedule shown in FIG. 2C is completed, the apparatus waits for input of the start instruction by the user (or the operator) (s20). When the start instruction is given, the play schedule which is stored in the hard disc 11 is sequentially read out with starting from the beginning (s21), and video data on the designated one of news, commercials, and trailers is read out (s22). If the read out video data is of a file of the same MPEG format as the movie main part (s23), the video data is supplied as it is to the MPEG decoder 13 (s24). If the read out video data is not of an MPEG format file (s23), the video data is developed into images to be reconverted into data of the MPEG format (s25), and the MPEG data is supplied to the MPEG decoder 13 (s26). This operation is performed on all of the news, commercials, and trailers which are written in the play schedule (s27). Thereafter, the DVD drive 12 is activated to start the play of the movie main part (s28).

In the embodiment, news, commercials, and trailers are played by using the MPEG decoder 13, the projector 3, the screen (not shown), and the like which are hardwares for playing the movie main part. Alternatively, hardwares for commercials may be disposed in addition to the hardwares for the movie main part, and commercials and news may be played in parallel with the movie main part. Subtitles of a movie may be edited as sequence data for sequentially displaying text data of the same format as a word track of karaoke music data, and displayed in parallel with the movie main part. In this case, subtitles are not printed into the main part of a movie, and hence it is possible to display subtitles of any language as required (or not to display subtitles).

A sales method may be employed in which the apparatus is set so that, in accordance with the manufacturer of the apparatus (the video playback control apparatus 1) contained in the apparatus conditions, a commercial of the manufacturer is downloaded, and the commercial is always played, whereby the price of the apparatus is reduced.

As described above, according to the present invention, long-time video data on the main part of a movie etc., and video data on a trailer etc. which is to be replaced with another one can be played back with being freely combined with each other. Therefore, a movie can be played with being combined with optimum trailers, commercials, etc., in accordance with various conditions of the genre of the movie, the day of week, etc.

It is contemplated that numerous modifications may be made to the video playback control apparatus and the video playback control method of the present invention without departing from the spirit and scope of the invention as defined in the following claims.

What is claimed is:

1. A video playback control apparatus which continuously plays back first video data supplied from a medium and second video data supplied from a communication system, while combining the first and second video data with each other.

2. The video playback control apparatus of claim 1, wherein the first video data is video data on a main part of a movie, and the second video data is video data on at least one of a trailer and an advertisement.

3. The video playback control apparatus of claim 2, wherein the trailer and the advertisement are to be played prior to the main part of the movie.

4. The video playback control apparatus of claim 1, wherein plural sets of the second video data are supplied from the communication system, and wherein at least one of the sets of the second video data, and the first video data are continuously played back while being combined with each other.

5. The video playback control apparatus of claim 4 , wherein the at least one of the sets of the second video data, which is combined with the first video data, is selected on the basis of at least one of conditions of a manufacturer of the video playback control apparatus and an installation site, conditions of a time and day of week in which the first video data is to be played back, and information on a kind of the first video data.

6. The video playback control apparatus of claim 2, wherein plural sets of the second video data are supplied from the communication system, and wherein at least one of the sets of the second video data, and the first video data are continuously played back while being combined with each other.

7. The video playback control apparatus of claim 6, wherein the at least one of the sets of the second video data, which is combined with the first video data, is selected on the basis of at least one of conditions of a manufacturer of the video playback control apparatus and an installation site, conditions of a time and day of week in which the first video data is to be played back, and information on a kind of the first video data.

8. A video playback control apparatus, comprising:
a medium reading section which outputs first video data recorded on a medium;
a communication control section which receives second video data via a communication device from a separate distribution center that is disposed independently of the video playback control apparatus; and
a control section, to which the medium playback section and the communication control section are connected, and which controls the first video data and the second video data so that the first video data and the second video data are continuously played back while being combined with each other.

9. The video playback control apparatus of claim 8, wherein the first video data is video data on a main part of a movie, and the second video data is video data on at least one of a trailer and an advertisement.

10. The video playback control apparatus of claim 9, wherein the trailer and the advertisement are to be played prior to the main part of the movie.

11. The video playback control apparatus of claim 8, wherein plural sets of the second video data are supplied from the communication system, and wherein a t least one of the sets of the second video data, and the first video data are continuously played back while being combined with each other.

12. The video playback control apparatus of claim 11, wherein the at least one of the sets of the second video data, which is combined with the first video data, is selected on the basis of at least one of conditions of a manufacturer of the video playback control apparatus and an installation site, conditions of a time and day of week in which the first video data is to be played back, and information on a kind of the first video data.

13. The video playback control apparatus of claim 9, wherein plural sets of the second video data are supplied from the communication system, and wherein at least one of the sets of the second video data, and the first video data are continuously played back while being combined with each other.

14. The video playback control apparatus of claim 13, wherein the at least one of the sets of the second video data, which is combined with the first video data, is selected on the basis of at least one of conditions of a manufacturer of the video playback control apparatus and an installation site, conditions of a time and day of week in which the first video data is to be played back, and information on a kind of the first video data.

15. A video playback control method, comprising:
reading first video data recorded on a medium;
receiving second video data from a communication system; and
continuously playing back the first video data and the second video data while combining the first and second video data with each other.

16. The video playback control method of claim 15, wherein the first video data is video data on a main part of a movie, and the second video data is video data on at least one of a trailer and an advertisement.

17. The video playback control method of claim 16, wherein the trailer and the advertisement are to be played prior to the main part of the movie.

18. The video playback control method of claim 15, wherein, in the receiving step, plural sets of the second video data are supplied from the communication system, and wherein at least one of the sets of the second video data, and the first video data are continuously played back while being combined with each other.

19. The video playback control method of claim 18, further comprising:
selecting at least one set from the sets of the second video data, which is combined with the first video data, on the basis of at least one of conditions of a manufacturer of the video playback control apparatus and an installation site, conditions of a time and day of week in which the first video data is to be played back, and information on a kind of the first video data.

20. The video playback control method of claim 16, wherein, in the receiving step, plural sets of the second video data are supplied from the communication system, and wherein at least one of the sets of the second video data, and the first video data are continuously played back while being combined with each other.

21. The video playback control method of claim 20, further comprising:
selecting at least one set from the sets of the second video data, which is combined with the first video data, on the basis of at least one of conditions of a manufacturer of the video playback control apparatus and an installation site, conditions of a time and day of week in which the first video data is to be played back, and information on a kind of the first video data.
